(19) United States
(12) Patent Application Publication
(10) Pub. No.: US 2002/0038583 A1
(43) Pub. Date: Apr. 4, 2002

(54) Adjustable wrench with staggering prevention

(76) Inventor: Bobby Hu, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/934,116

(22) Filed: Aug. 20, 2001

(30) Foreign Application Priority Data
Aug. 29, 2000 (TW) 89214967

(51) Int. Cl. B25B 13/16

(52) U.S. Cl. 81/170

(57) ABSTRACT

An adjustable wrench includes a handle and a head extended from the handle. The head includes a fixed jaw, a movable jaw, and an adjusting screw. The movable jaw is rectilinearly movable relative to the fixed jaw upon rotation of the adjusting screw. The movable jaw includes a rack portion that is slidably received in a track groove in the head. The rack portion is in surface contact with an inner peripheral wall defining the track groove to thereby prevent staggering of the movable jaw.

### BACKGROUND OF THE INVENTION

1. Field of the Invention

The present invention relates to an adjustable wrench wherein staggering of the movable jaw thereof is prevented.

2. Description of the Related Art

It is well known to use an adjustable wrench for holding and driving fasteners (e.g., nuts, bolts, etc.) of various sizes. FIGS. 21 and 22 of the drawings illustrate a conventional adjustable wrench 200 comprising a fixed jaw 65, a movable jaw 61, and an adjusting screw 64. Manufacture of adjustable wrenches is the most difficult among all of the hand tools since the highest precision is required for the adjustable wrenches. Referring to FIG. 22, the movable jaw 61 includes a rack portion 612 slidingly received in a track groove 63 (FIG. 21) in a head 60 of the adjustable wrench 200. The rack portion 612 of the movable jaw 61 meshes with the adjusting screw 64 such that the movable jaw 61 is moved relative to the fixed jaw 65 upon rotation of the adjusting screw 64. However, gaps exist in four places A, B, C, D in the adjustable wrench to allow easy movement of the movable jaw 61 in the track groove 63, as shown in FIG. 21. However, if the gaps are too large, the movable jaw 61 often fails to reliably and effectively clamp the fastener. As a result, the corner areas of a hexagonal outer periphery of the fastener will be damaged, and this is why the adjusting wrenches are notorious as “nut killers”. To the contrary, if the gaps are too small, the rack portion 612 of the movable jaw 61 cannot move smoothly in the track groove 63 and thus fails to clamp the fastener. Damage to the fastener occurs accordingly.

### SUMMARY OF THE INVENTION

It is an object of the present invention to provide an adjustable wrench wherein staggering of the movable jaw thereof is prevented.

An adjustable wrench in accordance with the present invention includes a handle and a head extended from the handle. The head includes a fixed jaw, a movable jaw, and, in the preferred form, an adjusting screw for moving the movable jaw relative to the fixed jaw and for retaining the movable jaw in place relative to the fixed jaw. The movable jaw is rectilinearly movable relative to the fixed jaw upon rotation of the adjusting screw. The movable jaw includes a rack portion that is slidably received in a track groove in the head. The rack portion is in surface contact with an inner peripheral wall defining the track groove to thereby prevent staggering of the movable jaw.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a head portion of an adjustable wrench in accordance with the present invention.

FIG. 2 is an exploded perspective view of the head portion of the adjustable wrench in FIG. 1.

FIG. 3 is a side view, partly sectioned, of the head portion of the adjustable wrench in FIG. 1.

FIG. 4 is a top view, partly sectioned, of the head portion of the adjustable wrench in FIG. 1.

FIG. 5A is a partly sectioned side view illustrating the difference between the adjustable wrench and the conventional adjustable wrench.

FIG. 5B is an enlarged view of a portion of FIG. 5A.

FIG. 6A is an enlarged view similar to FIG. 5B, illustrating the difference between a modified embodiment of the adjustable wrench and the conventional adjustable wrench.

FIG. 6B is an enlarged view similar to FIG. 5B, illustrating the difference between another modified embodiment of the adjustable wrench and the conventional adjustable wrench.

FIG. 7A is an enlarged view similar to FIG. 5B, illustrating the difference between a further modified embodiment of the adjustable wrench and the conventional adjustable wrench.

FIG. 7B is an enlarged view similar to FIG. 5B, illustrating the difference between still another modified embodiment of the adjustable wrench and the conventional adjustable wrench.

FIG. 8 is an exploded perspective view of a second embodiment of the head portion of the adjustable wrench in accordance with the present invention.

FIG. 9 is a side view, partly sectioned, of the head portion of the adjustable wrench in FIG. 8.

FIG. 10 is a top view, partly sectioned, of the head portion of the adjustable wrench in FIG. 8.

FIG. 11 is a side view, partly sectioned, of a third embodiment of the head portion of the adjustable wrench in accordance with the present invention.

FIG. 12 is a top view, partly sectioned, of the head portion of the adjustable wrench in FIG. 11.

FIG. 13 is a side view, partly sectioned, of a fourth embodiment of the head portion of the adjustable wrench in accordance with the present invention.

FIG. 14 is a top view, partly sectioned, of the head portion of the adjustable wrench in FIG. 13.

FIG. 15 is an exploded perspective view of a fifth embodiment of the head portion of the adjustable wrench in accordance with the present invention.

FIG. 16 is a side view, partly sectioned, of the head portion of the adjustable wrench in FIG. 15.

FIG. 17 is a top view, partly sectioned, of the head portion of the adjustable wrench in FIG. 15.

FIG. 18 is an exploded perspective view of a sixth embodiment of the head portion of the adjustable wrench in accordance with the present invention.

FIG. 19 is a side view, partly sectioned, of the head portion of the adjustable wrench in FIG. 18.

FIG. 20 is a top view of the head portion of the adjustable wrench in FIG. 18.

FIG. 21 is a perspective view of a head portion of a conventional adjustable wrench.

FIG. 22 is a side view of the conventional adjustable wrench in FIG. 21.

### DETAILED DESCRIPTION OF THE PREFERRED EMBODIMENTS

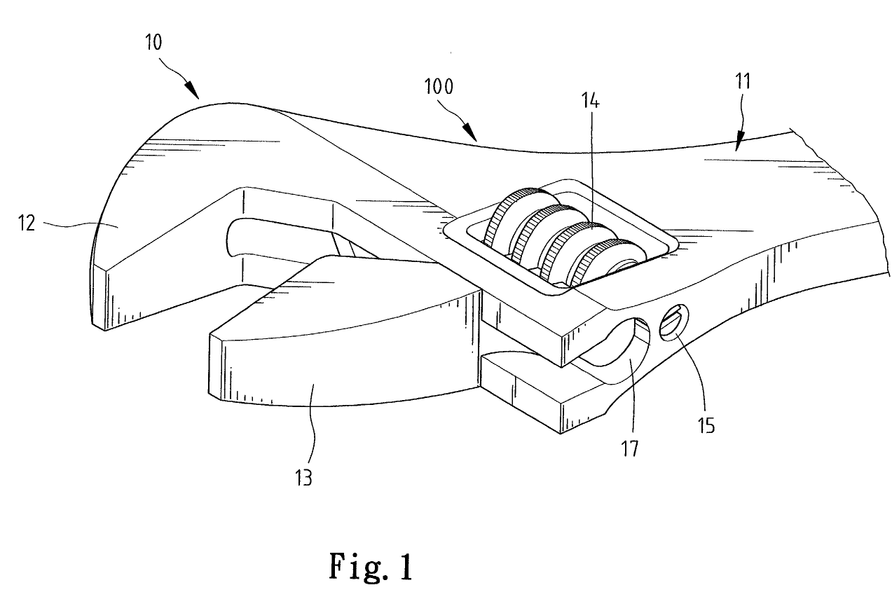

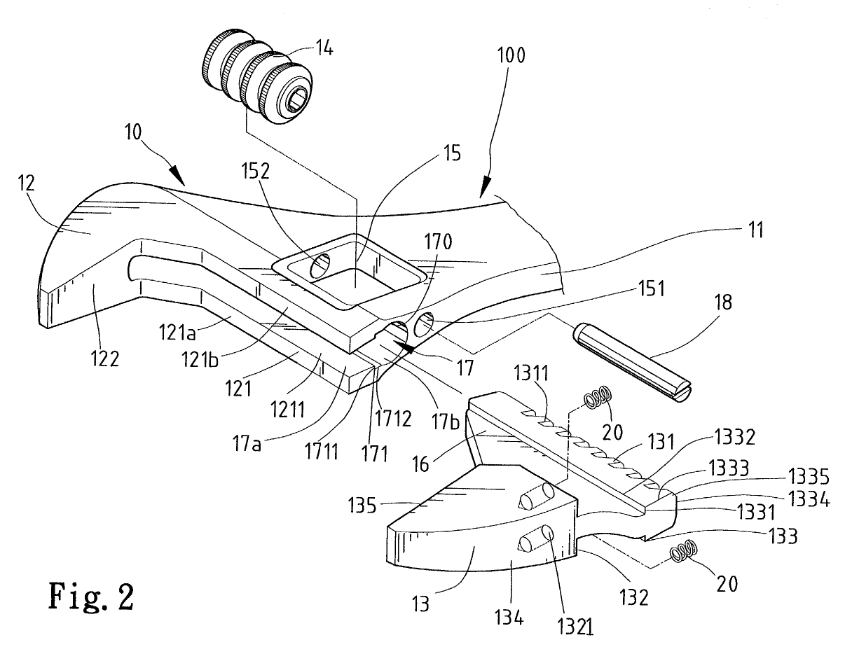

Referring to FIGS. 1 through 20 and initially to FIGS. 1 through 4, a first embodiment of an adjustable wrench 100 in accordance with the present invention generally includes a handle 11 and a head 10 extended from the handle 11. The head 10 includes a fixed jaw 12 formed on a side thereof and a movable jaw 13 slidably mounted thereon. The other side of the head 10 includes a track groove 17 defined therein along which a rack portion 131 of the movable jaw 13 is moved. The other side of the head 10 includes two mutually facing upper and lower side walls 121 that extend toward an inner clamping surface 122 of the fixed jaw 12. As illustrated in FIG. 2, the track groove 17 includes an outer portion 17a defined by two inner lateral surfaces 1211 respectively of the side walls 121 and an inner portion 17b defined by an inner cylindrical wall 170. Each inner surface 1211 has a ledge 171 defined between the inner portion 17b and the outer portion 17a and having a vertical section or portion 1711 and a horizontal section or portion 1712 as viewed from the direction of FIG. 2. In the forms shown in FIGS. 1-5B, 7A, 7B and 12-17, the horizontal portions 1712 are planar. The term “horizontal” used herein means a direction parallel to or located on a longitudinal plane on which the adjustable wrench locates. The term “vertical” used herein means a direction orthogonal to the longitudinal plane on which the adjustable wrench locates. The inner cylindrical wall 170 extends from the horizontal sections or portions 1712 of ledges 171 and has a diameter greater than the spacing between the vertical sections or portions 1711 of the two inner lateral surfaces 1211.

Still referring to FIG. 2, the head 10 of the adjustable wrench 100 further includes an opening or compartment 15 for rotatably receiving an adjusting/positioning means (e.g., an adjusting screw 14) that meshes with the rack portion 131 of the movable jaw 13. A blind hole 152 is defined in a wall (not labeled) that defines a portion of the compartment 15, and a hole 151 is defined in another wall (not labeled) that defines another portion of the compartment 15 and that faces the wall with the blind hole 152, best shown in FIG. 2. A pin or axle 18 is extended through the holes 151 and 152 and a longitudinal hole (not labeled) of the adjusting screw 14, thereby rotatably mounting the adjusting screw 14 in the compartment 15. The adjusting screw 14 may rotate freely in the compartment 15 for moving the movable jaw 13 away from or toward the fixed jaw 12 and for retaining the movable jaw 13 in place relative to the fixed jaw 12. The adjusting screw 14 has a helical anti-slip surface (not labeled) to avoid slip during manual rotation.

The movable jaw 13 includes a clamping portion 134 with a clamping surface 135 facing the clamping surface 122 of the fixed jaw 12. The movable jaw 13 further includes the above-mentioned rack portion 131 and an intermediate portion 16 between the rack portion 131 and the clamping portion 134. A shoulder (not labeled) is defined in a joint area between the intermediate portion 16 and the rack portion 131 and includes two opposite ledges 133 each having a vertical portion 1331 and a horizontal portion 1332 as viewed from the direction of FIG. 2. In the embodiments of FIGS. 1-6A and 12-17, the horizontal portions 1332 are perpendicular to the vertical portions 1331, and the vertical portions 1331 are perpendicular to the intermediate portion 16.

In preferred forms, the rack portion 131 includes first and second, planar, parallel sides 1333 spaced less than the diameter of the inner cylindrical wall 170 and greater than the two inner lateral surfaces 1211 and extending from the respective horizontal portions 1332. In the embodiments of FIGS. 1-6A, 7B, and 12-17, the horizontal portions 1332 and the sides 1333 are each planar and coplanar. The rack portion 131 further includes a planar end 1334 arranged between and in the preferred form perpendicular to the first and second sides 1333 opposite to the shoulders of the movable jaw 13. First and second arcuate portions 1335 extend between the end 1334 and the first and second sides 1333, respectively. Arcuate portions 1335 have a radius corresponding to and for slidable engagement with the inner cylindrical wall 170. The planar nature of the sides 1333 and of the end 1334 of the preferred forms creates voids with the inner cylindrical wall 170 having D-shaped cross sections and allows the rack portion 131 to have relaxed manufacturing tolerances. The intermediate portion 16 of the movable jaw 13 is slidably received in the outer portion 17a of the track groove 17 defined between the inner lateral surfaces 1211 of the side walls 121. The rack portion 131 is slidably received in the inner portion 17b of the track groove 17 and meshes with the adjusting screw 14.

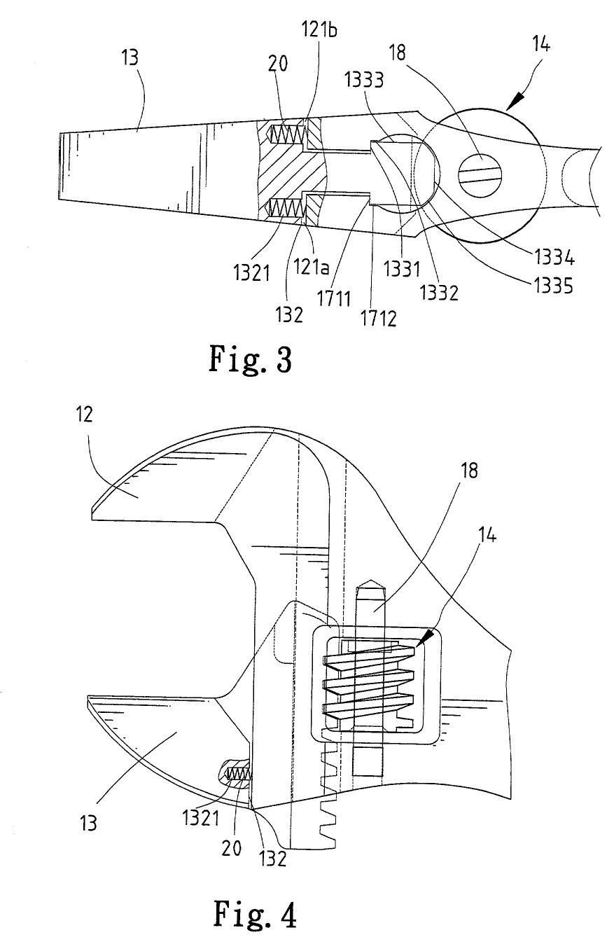

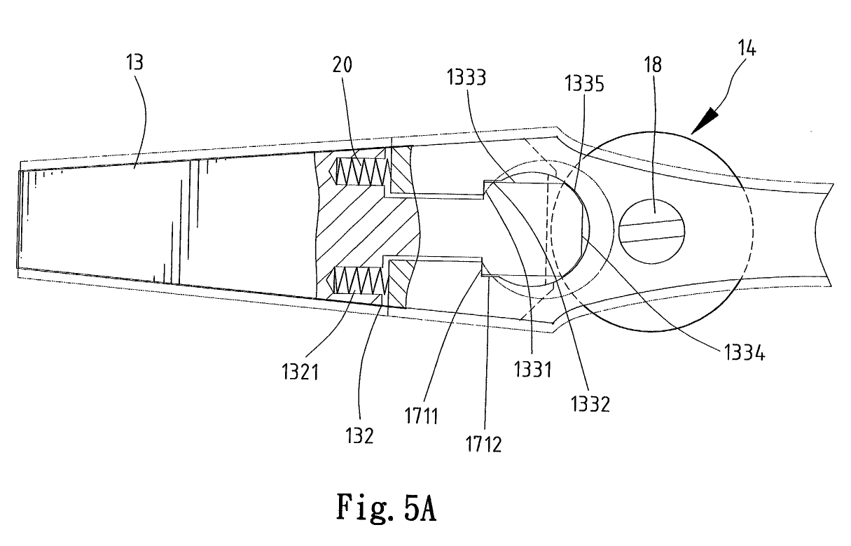

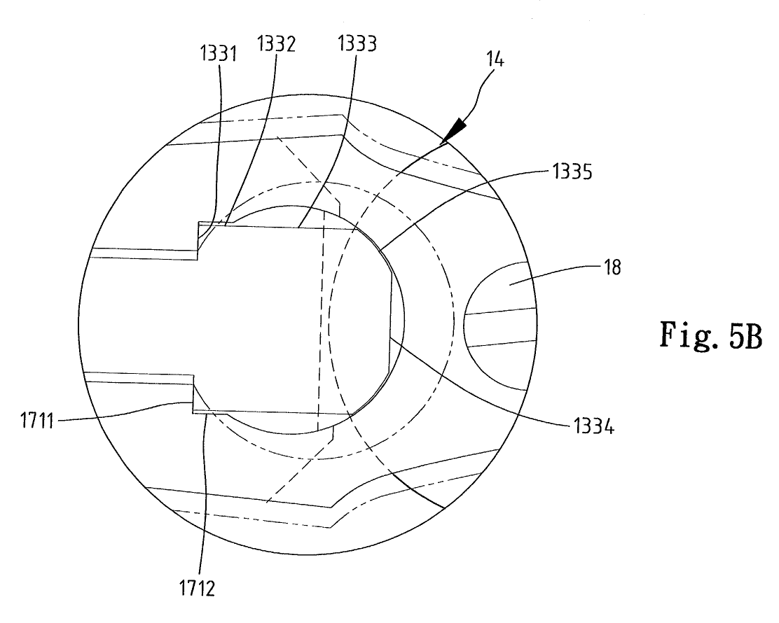

In addition and in a preferred form, the clamping portion 134 of the movable jaw 13 includes two receptacles 1321 defined in an end face 132 facing the rack portion 131. Each receptacle 1321 extends in a direction transverse to a moving direction of the movable jaw 13. A biasing means (e.g., a spring 20) is mounted in each receptacle 1321 and includes a first end abutting an end wall of the receptacle 1321 and a second end directly abutting with and sliding on an outwardly facing slide surface 121a, 121b of the associated side wall 121, best shown in FIG. 3, with the slide surface 121a, 121b extending parallel to the moving direction of the movable jaw 13. The slide surfaces 121a and 121b are planar and specifically do not include recesses or the like which could receive the second end of the spring 20 or other form of biasing means resulting in a removable locked engagement or otherwise in an impediment to the free movement of the movable jaw 13 relative to the head 10. Thus, the movable jaw 13 is biased outward under the action of the springs 20 such that the vertical portions 1331 of the ledges 133 of the movable jaw 13 are in surface contact with the vertical portions 1711 of the ledges 171 of the track groove 17, best shown in FIGS. 5A and 5B. Thus, the gap between the movable jaw 13 and the inner lateral surfaces 1211 of the track groove 17 is eliminated to thereby prevent staggering of the movable jaw 13 when the movable jaw 13 is moved relative to the fixed jaw 12 upon manually rotating the adjusting screw 14. FIGS. 5A and 5B also illustrate the structure of a conventional adjustable wrench to clearly show the difference between the conventional adjustable wrench and the adjustable wrench in accordance with the present invention.

A further advantage of such design is that the tolerance between the movable jaw 13 and the inner lateral surfaces 1211 of the track groove 17 can be ignored when manufacturing the adjustable wrench 100, for the gap therebetween will be eliminated under the action of the springs 20. Another advantage of this design resides in that the adjustable wrench 100 may bear higher torque due to the above-mentioned surface contact between the ledges 171 and 133. In the conventional adjustable wrench, a gap always exists between the rack portion 612 of the movable jaw 61 and the track groove 63 due to the cylindrical surface contact therebetween.

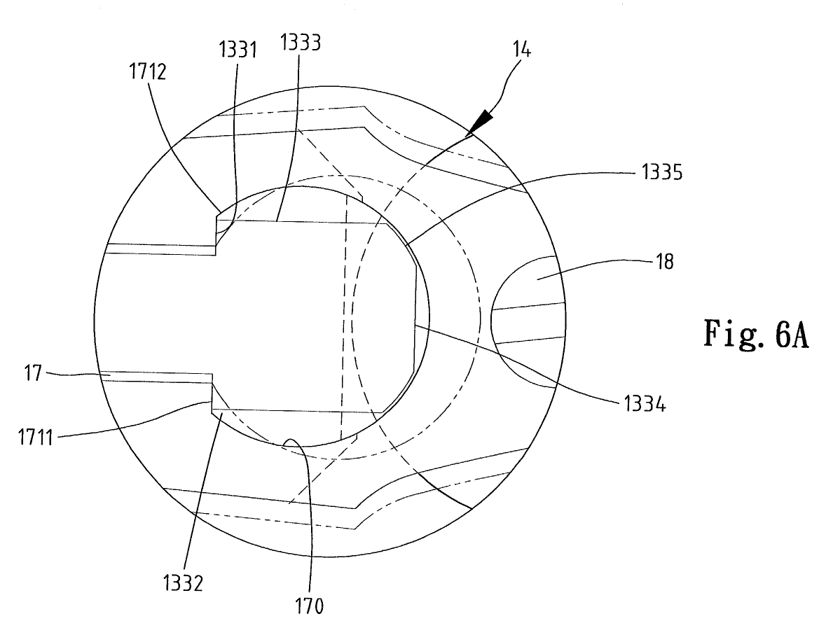

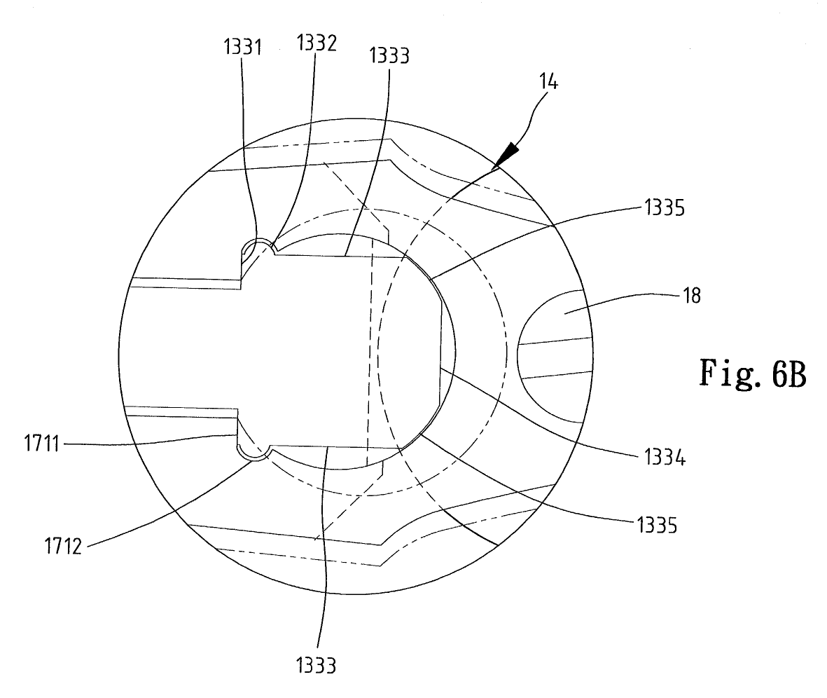

FIG. 6A illustrates a modified embodiment of the adjustable wrench, wherein the horizontal portions 1712 of the ledges 171 are arcuate of a radius corresponding to and contiguous with the inner cylindrical wall 170 of the track groove 17. The vertical portions 1711 of the ledges 171 are in surface contact with the vertical portions 1331 of the rack portion 131.

FIG. 6B illustrates another modified embodiment of the adjustable wrench, wherein the horizontal portion 1712 of each ledge 171 and the horizontal portion 1332 of each ledge 133 of the rack portion 131 are arcuate having a radius considerably smaller than the radius of the arcuate portions 1335 and than one-half of the spacing between the two inner lateral surfaces 1211. In the preferred form, the horizontal portions 1712 and 1332 of FIG. 6B have generally semicircular cross sections having first edges integrally connected to the vertical portions 1711 and 1331 respectively and having second edges integrally connected to the inner portion 17b and to the sides 1333 of the rack portion 131 respectively. The sides 1333 are spaced less than the maximum spacing of the horizontal portions 1332. The vertical portions 1711 of the ledges 171 are in surface contact with the vertical portions 1331 of the rack portion 131.

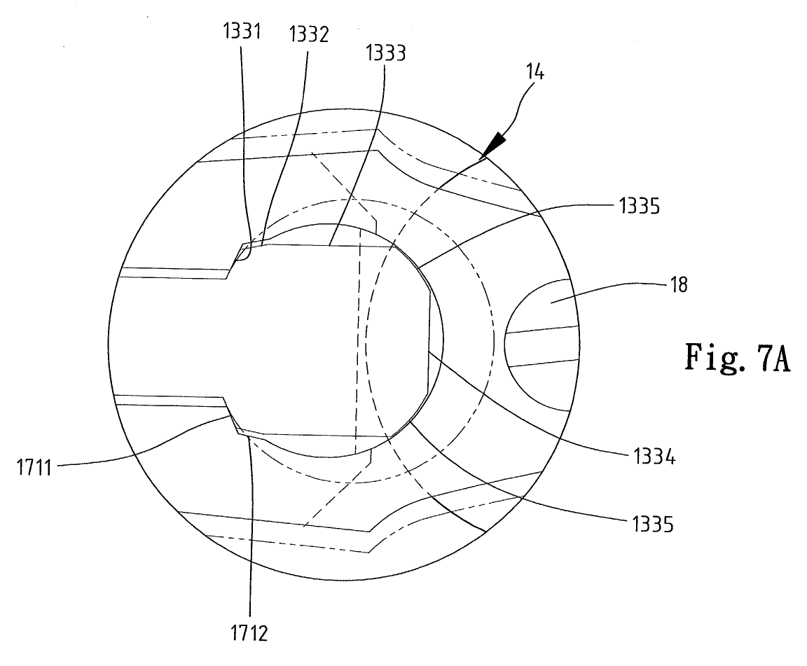

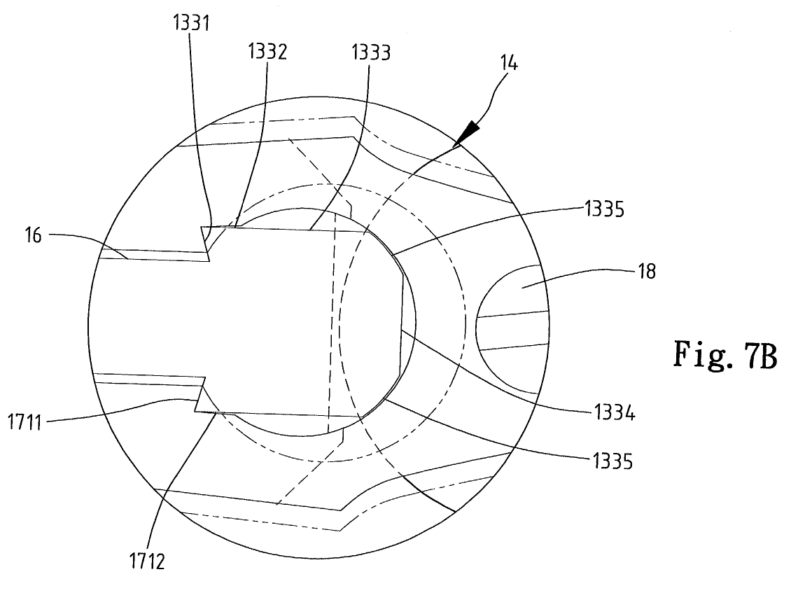

FIG. 7A illustrates a further modified embodiment of the adjustable wrench, wherein each vertical portion 1711 is at an obtuse angle with the associated horizontal portion 1712, and the vertical portion 1331 and the horizontal portion 1332 of the rack portion 131 are complimentarily formed. Vertical portions 1711 and 1331 of FIG. 7A are also at an obtuse angle relative to the two inner lateral surfaces 1211 and to the intermediate portion 16 respectively. Additionally, the horizontal portions 1332 are at an obtuse angle to the sides 1333 in the embodiment of FIG. 7A.

FIG. 7B illustrates still another modified embodiment of the adjustable wrench, wherein each vertical portion 1711 is at an acute angle with the associated horizontal portion 1712 and also with the intermediate portion 16, and the vertical portion 1331 and the horizontal portion 1332 of the rack portion 131 are complimentarily formed. It is noted that the vertical portions 1711 in both FIGS. 7A and 7B are in surface contact with the portions 1331 of the rack portion 131.

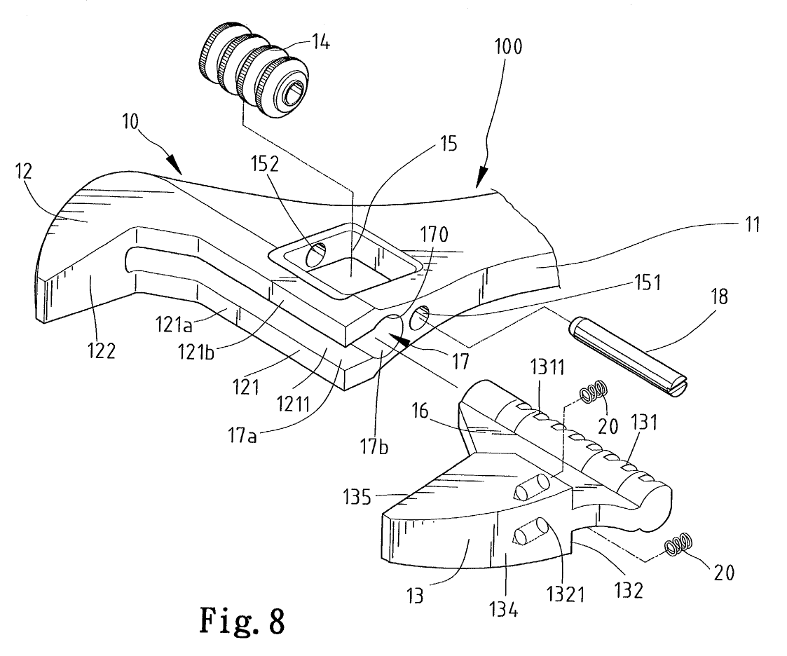

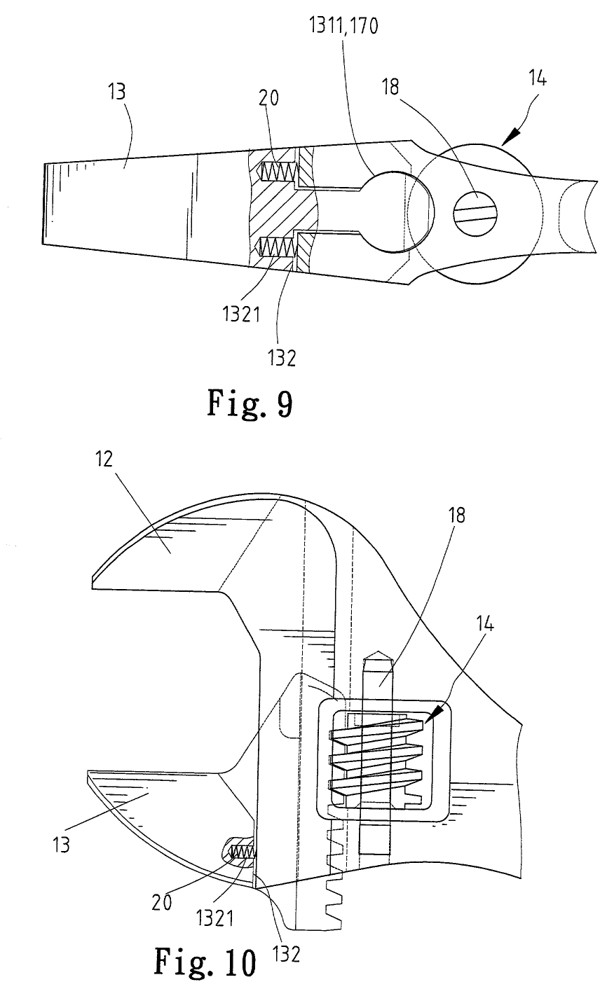

FIGS. 8 through 10 illustrate a second embodiment of the invention, wherein the ledges 171 of the track groove 17 and the ledges 133 of the movable jaw 13 are omitted. In addition, the rack portion 131 of the movable jaw 13 includes a substantially cylindrical surface 1311. In other words, the rack portion 131 includes first and second arcuate sides, an arcuate end, and first and second arcuate portions formed on the rack portion 131 opposite to the shoulder and extending between the first and second arcuate sides and the arcuate end and each having a radius corresponding to and for slidable engagement with the inner cylindrical wall 170. Thus, the gap between the rack portion 131 of the movable jaw 13 and the inner portion 17b of the track groove 17 is eliminated under the action of the springs 20 that bias the movable jaw 13 away from the head 10, as the cylindrical surface 1311 of the rack portion 131 of the movable jaw 13 is in surface contact with the inner cylindrical wall 170 of the inner portion 17b of the track groove 17, best shown in FIG. 9.

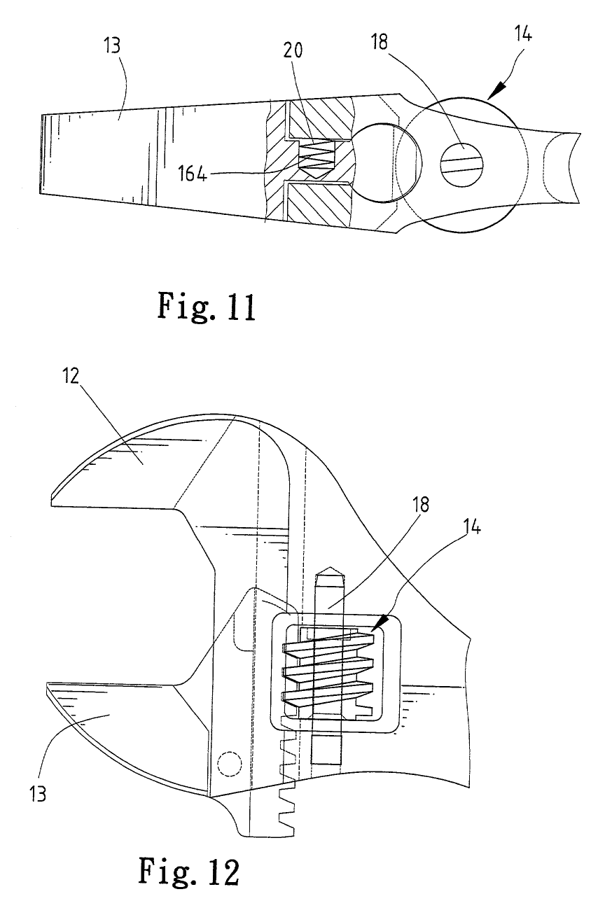

FIGS. 11 and 12 illustrate a third embodiment of the invention that is modified from the fifth embodiment shown in FIGS. 8 through 10, wherein the intermediate portion 16 of the movable jaw 13 includes a vertical receptacle 164 for receiving a spring 20 having a first end abutting with an end wall of the receptacle 164 and a second end directly abutting with and sliding on one of the two inner lateral surfaces 1211 of the track groove 16. Thus, the cylindrical surface 1311 of the rack portion 131 of the movable jaw 13 is biased to be in surface contact with the inner cylindrical wall 170 of the inner portion 17b of the track groove 17, best shown in FIG. 11.

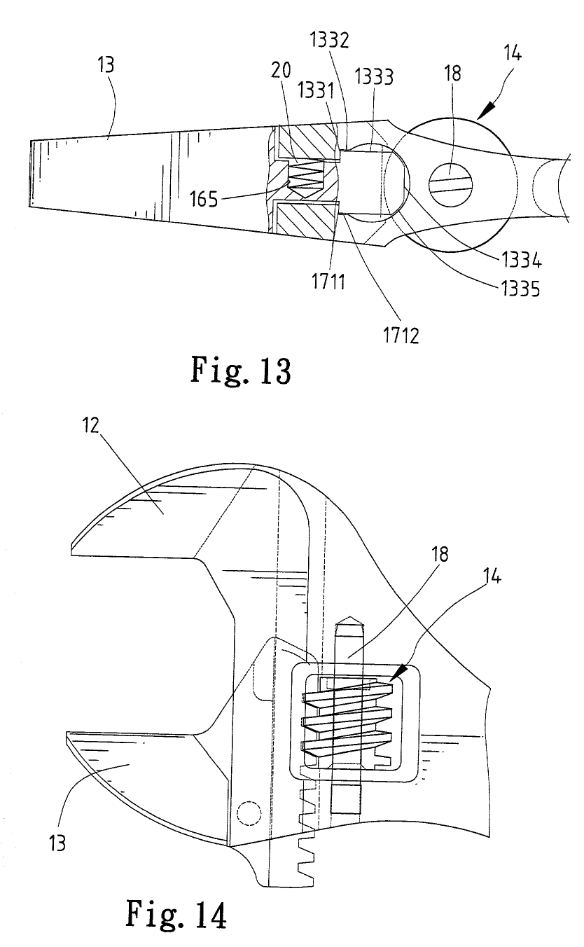

FIGS. 13 and 14 illustrate a fourth embodiment of the invention, wherein the ledges 133 and 171 are provided, and the intermediate portion 16 of the movable jaw 13 includes a vertical receptacle 165 for receiving a spring 20 having a first end abutting with an end wall of the receptacle 165 and a second end directly abutting with and sliding on the two inner lateral surfaces 1211 of the track groove 17. Thus, the horizontal portion 1332 of one of the ledges 133 of the movable jaw 13 is biased to be in surface contact with the horizontal portion 1712 of the associated ledge 171 of the track groove 17, best shown in FIG. 13.

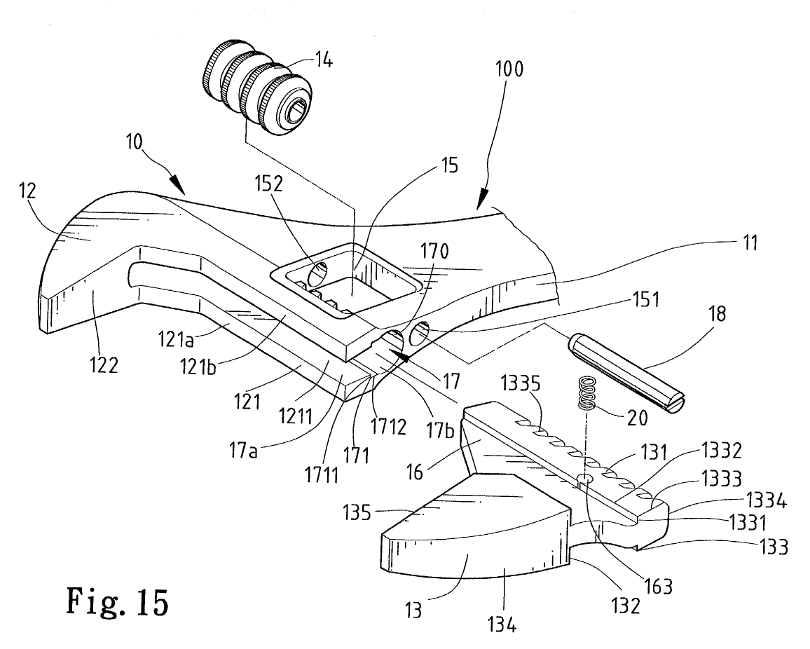

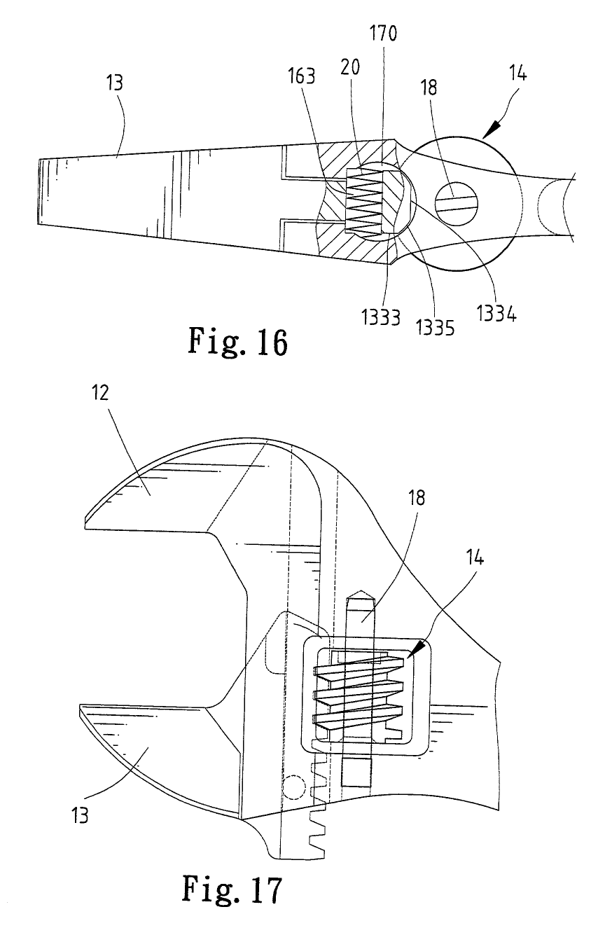

FIGS. 15 through 17 illustrate a fifth embodiment of the invention, wherein the ledges 133 and 171 are provided, and the of the movable jaw 13 includes a vertical receptacle or through-hole 163 for receiving a spring 20 that has two ends directly abutting with and sliding on spaced slide surfaces extending parallel to the moving direction and defined by the track groove 17. Thus, the horizontal portion 1332 of one of the ledges 133 of the movable jaw 13 is biased to be in surface contact with the horizontal portion 1712 of the associated ledge 171 of the track groove 17, best shown in FIG. 16.

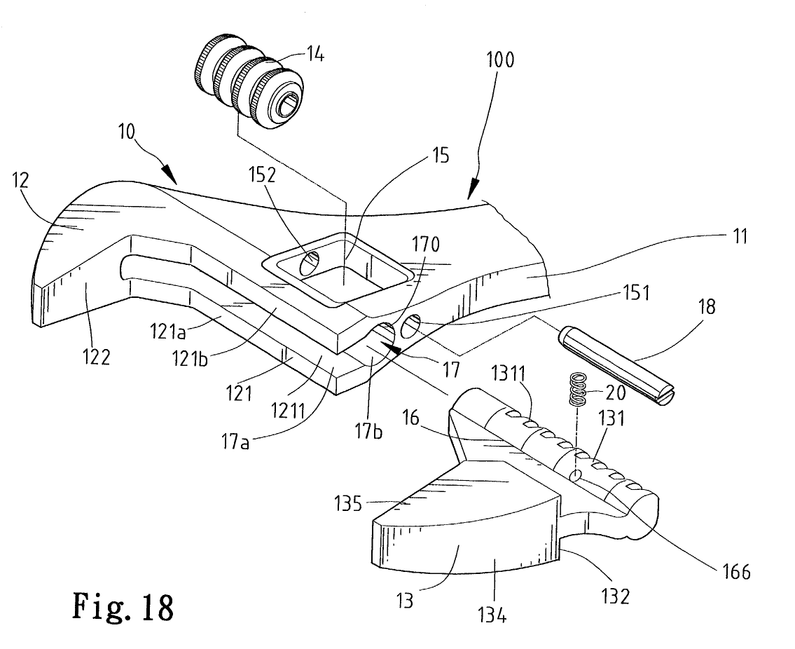

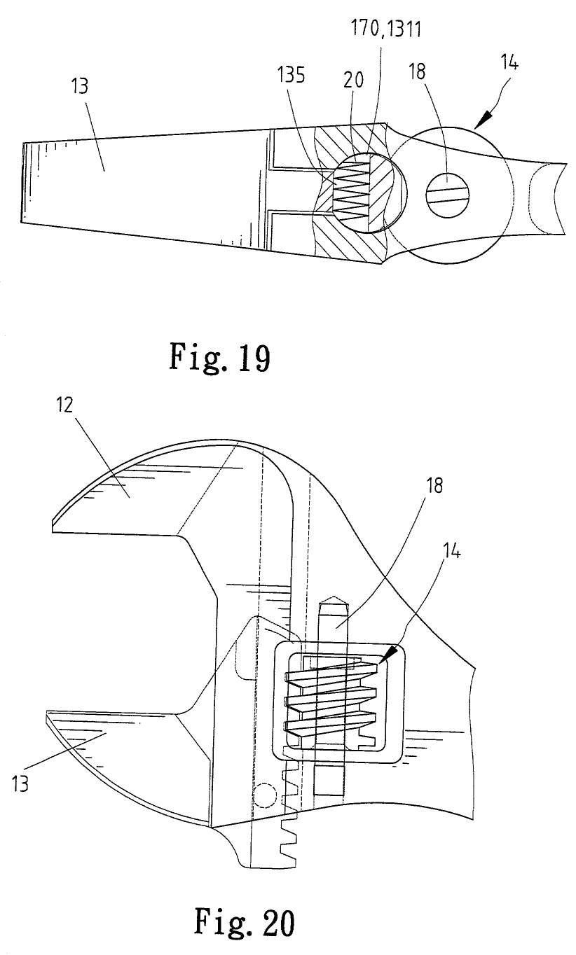

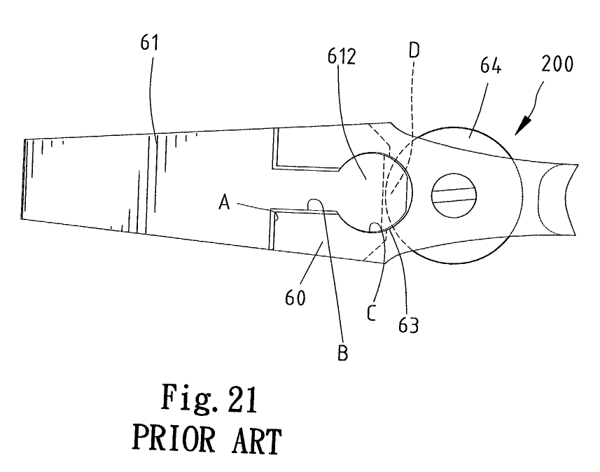

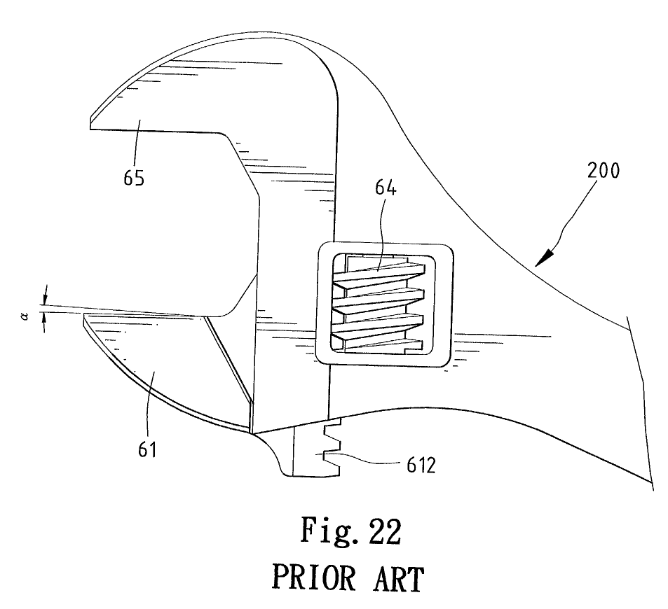

FIGS. 18 through 20 illustrate a sixth embodiment of the invention that is modified from the seventh embodiment shown in FIGS. 15 through 17, wherein the ledges 133 and 171 are omitted and wherein the rack portion 131 of the movable jaw 13 includes a substantially cylindrical surface 1311 and a vertical receptacle or through-hole 166 for receiving a spring 20 that has two ends directly abutting with and sliding on spaced slide surfaces extending parallel to the moving direction and defined by opposite wall portions of the inner cylindrical wall 170 of the track groove 17, best shown in FIG. 19. Thus, the cylindrical surface 1311 of the rack portion 131 of the movable jaw 13 is in surface contact with the inner cylindrical wall 170 of the inner portion 17b of the track groove 17 under the action of the spring 20.

Although the invention has been explained in relation to its preferred embodiments, it is to be understood that many other possible modifications and variations can be made without departing from the spirit and scope of the invention as hereinafter claimed.

What is claimed is:

1. An adjustable wrench comprising:
a handle;
a head extended from the handle, with the head including a fixed jaw and a track groove defined therein, with the track groove including an outer portion defined by two inner lateral surfaces respectively of two side walls of the head and an inner portion defined by an inner cylindrical wall, each said inner lateral surface including a ledge having a vertical section and a horizontal section, with the inner cylindrical wall extending from the horizontal sections and having a diameter greater than the spacing between the vertical sections of the two inner lateral surfaces; and
a movable jaw including a clamping portion, a rack portion, and an intermediate portion that is between the rack portion and the clamping portion, with a shoulder being defined in a joint area between the intermediate portion and the rack portion and including two opposite ledges each having a vertical portion facing an associated said vertical section of the track groove and a horizontal portion facing an associated said horizontal section of the track groove, with at least first and second arcuate portions being formed on the rack portion opposite to the shoulder and each having a radius corresponding to and for slidable engagement with the inner cylindrical wall, with the rack portion slidably received in the inner portion and the intermediate portion slidably received in the outer portion for moving the movable jaw relative to the fixed jaw, with the movable jaw being adapted to be retained in place relative to the fixed jaw;
at least one of the vertical portions and the horizontal portions of the movable jaw is in surface contact with an associated one of the vertical sections and the horizontal sections of the track groove when the movable jaw slides along the track groove.

2. The adjustable wrench as claimed in claim 1, with the rack portion including first and second parallel planar sides spaced less than the diameter of the inner cylindrical wall and extending from the respective horizontal portion, with the rack portion further including an end arranged between the first and second sides opposite to the shoulder, with the first and second arcuate portions extending between the first and second parallel planar sides and the end.

3. The adjustable wrench as claimed in claim 1, wherein each said vertical portion of the movable jaw is in surface contact with the associated vertical section of the track groove and each said horizontal portion of the movable jaw is in surface contact with the associated horizontal section of the track groove when the movable jaw slides along the track groove.

4. The adjustable wrench as claimed in claim 1, wherein the clamping portion of the movable jaw includes two receptacles defined in an end face thereof that faces the rack portion, each said receptacle extending in a direction transverse to a moving direction of the movable jaw, with the adjustable wrench further comprising a spring mounted in each said receptacle and including a first end abutting an inner end wall of an associated said receptacle and a second end abutting with and sliding on an outwardly facing slide surface of an associated one of the side walls defining the outer portion of the track groove and in a manner that does not impede moving the movable jaw relative to the fixed jaw in the moving direction, said springs biasing the movable jaw away from the track groove such that each said vertical section of the movable jaw is in surface contact with the associated vertical portion of the track groove.

5. The adjustable wrench as claimed in claim 1, wherein the movable jaw includes a vertical through-hole for receiving a spring therein, with the spring including two ends respectively abutting with and sliding on the track groove in a manner that does not impede moving the movable jaw relative to the fixed jaw in the moving direction, said spring biasing one of said horizontal portions of the movable jaw to be in surface contact with the associated horizontal section of the track groove.

6. The adjustable wrench as claimed in claim 1, wherein the intermediate portion of the movable jaw includes a vertical receptacle for receiving a spring therein, with the spring including a first end abutting with an inner end wall of the vertical receptacle and a second end abutting with and sliding on an associated said inner lateral surface of the track groove in a manner that does not impede moving the movable jaw relative to the fixed jaw in the moving direction, said spring biasing one of said horizontal portions of the movable jaw to be in surface contact with the associated horizontal section of the track groove.

7. The adjustable wrench as claimed in claim 1, wherein the rack portion of the movable jaw includes a vertical through-hole for receiving a spring therein, with the spring including two ends respectively abutting with and sliding on opposite wall portions of the inner cylindrical wall of the track groove in a manner that does not impede moving the movable jaw relative to the fixed jaw in the moving direction, said spring biasing the rack portion of the movable jaw to be in surface contact with the inner cylindrical wall of the track groove.

8. The adjustable wrench as claimed in claim 2, with the horizontal portions and the first and second sides each being planar and being coplanar.

9. The adjustable wrench as claimed in claim 8, with the horizontal portions being perpendicular to the vertical portions and the vertical portions being perpendicular to the intermediate portion.

10. The adjustable wrench as claimed in claim 9, with the horizontal sections being arcuate of a radius corresponding to and contiguous with the inner cylindrical wall.

11. The adjustable wrench as claimed in claim 9, with the horizontal sections being planar.

12. The adjustable wrench as claimed in claim 2, with the horizontal sections being arcuate of a radius corresponding to and contiguous with the inner cylindrical wall.

13. The adjustable wrench as claimed in claim 2, with the vertical portion being at an acute angle relative to the intermediate portion and the horizontal portion being at an acute angle relative to the vertical portion.

14. The adjustable wrench as claimed in claim 2, with the horizontal sections and the horizontal portions being arcuate of a radius considerably smaller than the radius of the first and second arcuate portions, with the horizontal portions having a spacing greater than the spacing between the first and second sides.

15. The adjustable wrench as claimed in claim 2, with the vertical portion being at an obtuse angle relative to the intermediate portion.

16. The adjustable wrench as claimed in claim 15, with the horizontal portion being at an obtuse angle relative to the vertical portion and relative to the respective side.

17. An adjustable wrench comprising:
a handle;
a head extended from the handle, with the head including a fixed jaw and a track groove;
a movable jaw including a clamping portion and a rack portion, with the rack portion being slidably received in the track groove for moving the movable jaw relative to the fixed jaw in a moving direction, with the movable jaw being adapted to be retained in place relative to the fixed jaw;
at least a first receptacle transverse to the moving direction and included in one of the movable jaw and the head;
a slide surface in the other of the movable jaw and the head and extending parallel to the moving direction; and
a spring received in the receptacle and having a first end and a second end, with the second end of the spring abutting with and sliding on the slide surface in a manner that does not impede moving the movable jaw relative to the fixed jaw in the moving direction for biasing the rack portion of the movable jaw to be in surface contact with the track groove when the movable jaw slides along the track groove.

18. The adjustable wrench as claimed in claim 17, wherein the movable jaw includes an intermediate portion between the rack portion and the clamping portion, with the track groove including an outer portion along which the intermediate portion slides, with the track groove further including an inner portion along which the rack portion slides.

19. The adjustable wrench as claimed in claim 18, wherein the rack portion includes a cylindrical surface and the inner portion of the track groove is defined by an inner cylindrical wall.

20. The adjustable wrench as claimed in claim 19, wherein the clamping portion of the movable jaw includes the first receptacle defined in an end face thereof that faces the rack portion, with an outwardly facing surface of an associated one of two side walls defining the outer portion of the track groove defining the slide surface, said spring biasing the cylindrical surface of the rack portion of the movable jaw to be in surface contact with the inner cylindrical wall of the track groove.

21. The adjustable wrench as claimed in claim 19, wherein the intermediate portion of the movable jaw includes the first receptacle with an associated said inner lateral surface of the track groove defining the slide surface, said spring biasing the cylindrical surface of the rack portion of the movable jaw to be in surface contact with the inner cylindrical wall of the track groove.

22. The adjustable wrench as claimed in claim 18, wherein the outer portion of the track groove is defined by two inner lateral surfaces respectively of two side walls of the head, with each said inner lateral surface including a ledge having a vertical section, the rack portion of the movable jaw including two opposite ledges each having a vertical portion that faces an associated said vertical section of the track groove, wherein the vertical portions of the movable jaw are respectively in surface contact with the vertical sections of the track groove when the movable jaw slides along the track groove.

23. The adjustable wrench as claimed in claim 18, wherein the outer portion of the track groove is defined by two inner lateral surfaces respectively of two side walls of the head, with each said inner lateral surface including a ledge having a vertical section and an arcuate horizontal section, with the rack portion of the movable jaw including two opposite ledges each having a vertical portion that faces an associated said vertical section of the track groove and an arcuate horizontal portion that faces an associated said arcuate horizontal section of the track groove, wherein the vertical portions of the movable jaw are respectively in surface contact with the vertical sections of the track groove when the movable jaw slides along the track groove.

24. The adjustable wrench as claimed in claim 18, wherein the outer portion of the track groove is defined by two inner lateral surfaces respectively of two side walls of the head, with each said inner lateral surface including a ledge having a first section and a second section that is at an obtuse angle with the first section, with the rack portion of the movable jaw including two opposite ledges each having a vertical portion that faces an associated said first section of the track groove and a second portion that faces an associated said second section of the track groove, with the first portion and the second portion of the movable jaw being complimentarily formed with respect to the first section and the second section of the track groove, wherein the vertical portions of the movable jaw are respectively in surface contact with the vertical sections of the track groove when the movable jaw slides along the track groove.

25. The adjustable wrench as claimed in claim 18, wherein the outer portion of the track groove is defined by two inner lateral surfaces respectively of two side walls of the head, with each said inner lateral surface including a ledge having a first section and a second section that is at an acute angle with the first section, with the rack portion of the movable jaw including two opposite ledges each having a vertical portion that faces an associated said first section of the track groove and a second portion that faces an associated said second section of the track groove, with the first portion and the second portion of the movable jaw being complimentarily formed with respect to the first section and the second section of the track groove, wherein the vertical sections of the movable jaw are respectively in surface contact with the vertical portions of the track groove when the movable jaw slides along the track groove.

26. The adjustable wrench as claimed in claim 17, with the first end of the spring abutting with an end wall of the receptacle.

27. The adjustable wrench as claimed in claim 17, further comprising, in combination: another slide surface in the other of the movable jaw and the head and extending parallel to the moving direction and spaced from the slide surface, with the first end of the spring abutting with and sliding on the other slide surface in a manner that does not impede moving the movable jaw relative to the fixed jaw in the moving direction.

28. An adjustable wrench comprising:
a handle;
a head extended from the handle, with the head including a fixed jaw and a track groove including an inner portion communicating with an outer portion;
a movable jaw including a clamping portion, a rack portion, and an intermediate portion between the rack portion and the clamping portion, with the rack portion being slidably received in the inner portion of the track groove and the intermediate portion being slidably received in the outer portion of the track groove for moving the movable jaw relative to the fixed jaw in a moving direction, with the movable jaw being adapted to be retained in place relative to the fixed jaw;
at least a first receptacle transverse to the moving direction and included in one of the intermediate portion and the outer portion of the track groove;
a slide surface in the other of the intermediate portion and the outer portion of the track groove and extending parallel to the moving direction; and
a spring received in the receptacle for biasing the intermediate portion towards the outer portion of the track groove.

29. The adjustable wrench as claimed in claim 28, with the spring having a first end abutting with an end wall of the receptacle and a second end abutting with and sliding on the slide surface in a manner that does not impede moving the movable jaw relative to the fixed jaw in the moving direction.

30. An adjustable wrench comprising:
a handle;
a head extended from the handle, with the head including a fixed jaw and a track groove defined therein, with the track groove including an outer portion defined by two inner lateral surfaces respectively of two side walls of the head and an inner portion, with each said inner lateral surface including a ledge having a vertical section and a horizontal section; and
a movable jaw including a clamping portion, a rack portion, and an intermediate portion that is between the rack portion and the clamping portion, with a shoulder being defined in a joint area between the intermediate portion and the rack portion and including two opposite ledges each having a vertical portion facing an associated said vertical section of the track groove and a horizontal portion facing an associated said horizontal section of the track groove, with the horizontal sections and the horizontal portions being arcuate of a radius considerably smaller than one-half of the spacing between the two inner lateral surfaces of the outer portion, with the rack portion slidably received in the inner portion and the intermediate portion slidably received in the outer portion for moving the movable jaw relative to the fixed jaw, with the movable jaw being adapted to be retained in place relative to the fixed jaw;
at least one of the vertical portions and the horizontal portions of the movable jaw is in surface contact with an associated one of the vertical sections and the horizontal sections of the track groove when the movable jaw slides along the track groove.

31. The adjustable wrench as claimed in claim 30, with the horizontal sections and horizontal portions having generally semicircular cross sections having first edges integrally connected to the vertical sections and the vertical portions respectively and having second edges integrally connected to the inner portion and to the rack portion respectively.

32. The adjustable wrench as claimed in claim 31, with the rack portion including first and second parallel sides spaced less than the maximum spacing of the horizontal portions and extending from the second edges of the horizontal portions, with the rack portion further including an end arranged perpendicular to the first and second sides opposite to the shoulder.

33. The adjustable wrench as claimed in claim 32, with the inner portion being defined by an inner cylindrical wall extending from the second edges of the horizontal sections, with the rack portion further including first and second arcuate portions extending between the first and second sides and the end respectively and each having a radius corresponding to and for slidable engagement with the inner cylindrical wall.

34. An adjustable wrench comprising:
a handle;
a head extended from the handle, with the head including a fixed jaw and a track groove defined therein, with the track groove including an outer portion defined by two inner lateral surfaces respectively of two side walls of the head and an inner portion, with each said inner lateral surface including a ledge having a vertical section and a horizontal section; and
a movable jaw including a clamping portion, a rack portion, and an intermediate portion that is between the rack portion and the clamping portion, with a shoulder being defined in a joint area between the intermediate portion and the rack portion and including two opposite ledges each having a vertical portion facing an associated said vertical section of the track groove and a horizontal portion facing an associated said horizontal section of the track groove, with the vertical portions and the vertical sections being at an obtuse angle relative to the intermediate portion and to the two lateral surfaces of the two side walls respectively, with the horizontal portions and the horizontal sections being at an obtuse angle to the vertical portions and the vertical sections, respectively, with the rack portion slidably received in the inner portion and the intermediate portion slidably received in the outer portion for moving the movable jaw relative to the fixed jaw, with the movable jaw being adapted to be retained in place relative to the fixed jaw;
at least one of the vertical portions and the horizontal portions of the movable jaw is in surface contact with an associated one of the vertical sections and the horizontal sections of the track groove when the movable jaw slides along the track groove.

35. The adjustable wrench as claimed in claim 34, with the rack portion including first and second parallel planar sides spaced greater than the two inner lateral surfaces and extending from the horizontal portions at an obtuse angle.

36. The adjustable wrench as claimed in claim 35, with the rack portion further including an end arranged perpendicular to the first and second sides opposite to the shoulder, with the inner portion being defined by an inner cylindrical wall extending from the horizontal sections, with the rack portion further including first and second arcuate portions extending between the first and second sides and the end respectively and each having a radius corresponding to and for slidable engagement with the inner cylindrical wall.
